(19) United States
(12) Patent Application Publication
(10) Pub. No.: US 2014/0007220 A1
(43) Pub. Date: Jan. 2, 2014

(54) USE OF TELEPHONY FEATURES AND PHONES TO ENABLE AND DISABLE SECURE REMOTE ACCESS

(71) Applicant: AVAYA INC., Basking Ridge, NJ (US)

(72) Inventor: Martin Pepin, Gatineau (CA)

(73) Assignee: Avaya Inc., Basking Ridge, NJ (US)

(21) Appl. No.: 13/860,874

(22) Filed: Apr. 11, 2013

Related U.S. Application Data
(60) Provisional application No. 61/665,219, filed on Jun. 27, 2012.

(51) Int. Cl. H04L 29/06

(52) U.S. Cl. CPC H04L 63/0272
USPC 726/15

(57) ABSTRACT

System and method to control a virtual private network (VPN) connection, including the steps of: establishing a VPN connection between a VPN client associated with a communication terminal of an end-user and a remote VPN gateway; configuring the VPN client to recognize a shortcode provided by the communication terminal; and controlling the VPN connection based upon the shortcode.

### CROSS-REFERENCE TO RELATED APPLICATIONS

This application claims the benefit of U.S. Provisional Patent Application Ser. No. 61/665,219, filed on Jun. 27, 2012, the entire content of which is hereby incorporated by reference in its entirety.

### BACKGROUND

1. Field of the Invention

System and method to provide a less resource-intensive method to enable or disable security modules or components, in particular security-related software modules or components, the system and method usable by less robust terminals.

2. Description of Related Art

In a client/server environment, secure remote access is provided by security modules or components in both the client and server, which are configured to exchange encrypted communication. Controlling secure remote access may include enabling and/or disabling secure remote access, and which may include enabling and/or disabling the security modules or components that provide secure remote access.

The traditional way that a communications end-user is able to enable or disable security modules or components used to provide secure access is by using a configuration application program, web interface, or the like. Doing so requires a robust terminal having sufficient capabilities to support the configuration application program or render the web interface, etc. Such a robust terminal may not always be available, therefore it is not always possible for an end-user to open such an application or web interface to enable or disable Secure Sockets Layer (“SSL”) Virtual Private Network (“VPN”) service (i.e., a secure communication tunnel). Therefore, a need exists to enable or disable software components, in particular security-related software components, by less robust terminals.

### SUMMARY

Embodiments of the present invention generally relate to a system and method for enabling and/or disabling security modules or components, in particular security-related software modules or components, the embodiments usable by less robust terminals.

Embodiments in accordance with the present invention provide a system and method to control a virtual private network (VPN) connection, including the steps of: establishing a VPN connection between a VPN client associated with a communication terminal of an end-user and a remote VPN gateway; configuring the VPN client to recognize a shortcode provided by the communication terminal; and controlling the VPN connection based upon the shortcode.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 illustrates a system usable to control an SSL VPN tunnel from a phone or a PC connected to a domain manager in order to allow for secure remote access for support, in accordance with an embodiment of the present invention; and

FIG. 2 illustrates a process usable to control an SSL VPN tunnel in order to allow for secure remote access, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to utilize an end-user's telecommunication device to control a VPN tunnel.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “gateway” may generally comprise any device that sends and receives data between devices. For example, a gateway may comprise routers, switches, bridges, firewalls, other network elements, and the like, any and combination thereof.

As used herein, the term “transmitter” may generally comprise any device, circuit, or apparatus capable of transmitting an electrical signal.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

Embodiments in accordance with the present invention provide a system and method for enabling and/or disabling security modules or components, in particular security-related software modules or components, the embodiments usable by less robust terminals.

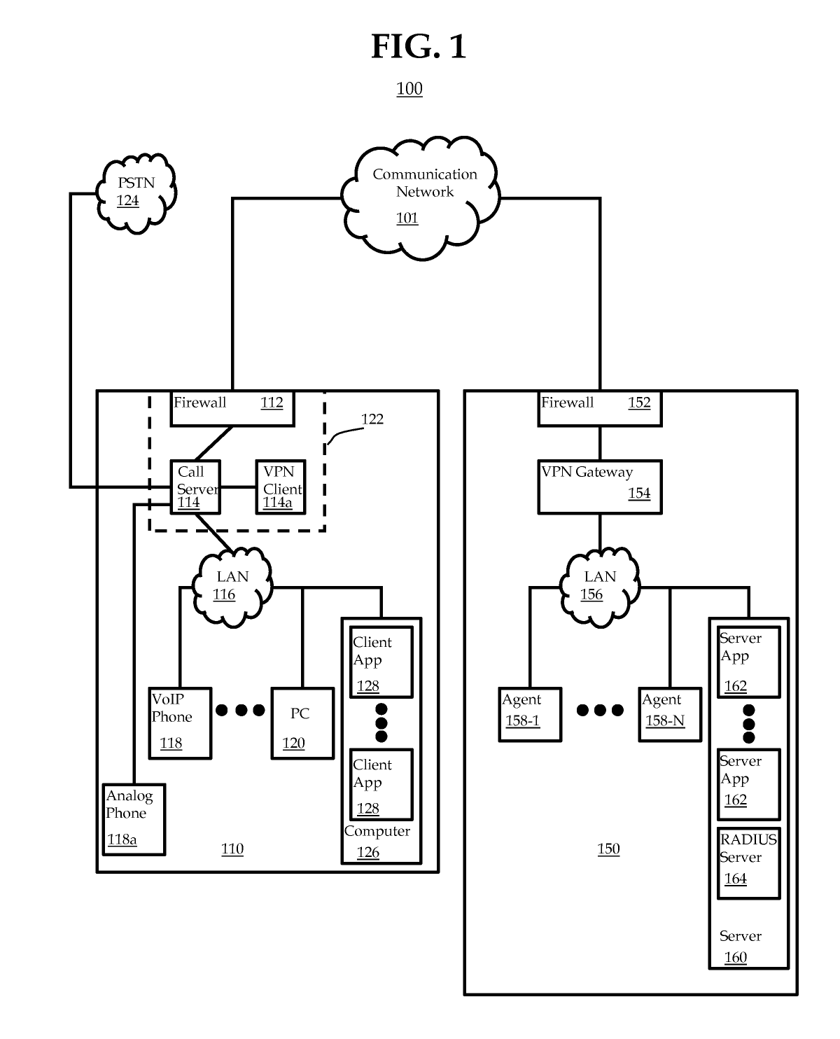

FIG. 1 depicts a communication system 100 according to an embodiment of the present disclosure. The communication system 100 may include a customer premises domain 110 and one or more server domains 150. A domain may be known as a group of data-processing systems that share a common communications address. The domains 110 and 150 are interconnected by communication network 101 such as the Internet or other wide-area network.

Customer premises domain 110 may include a firewall 112 that protects domain 110 from malicious attacks. Firewall 112 may be communicatively connected with Call Server 114 and VPN client 114a, which may be used to implement a secure client-server communication session (e.g., a SSL VPN tunnel). Both call server 114 and VPN client 114a may reside on SSL VPN client 122 and use the same IPv4 stack. However, both call server 114 and VPN client 114a have different functions. The IPv4 stack works through call server 114, whereas VPN client 114a terminates the SSL VPN tunnel that is controlled by call server 114.

VPN client 114a may be communicatively connected with one or more end-user communication devices, such as VoIP telephone 118 and/or PC 120, via LAN 116. VPN client 114a may also be communicatively connected with one or more analog telephones 118a. Call Server 114 may also provide an interface to public-switched telephone network (“PSTN”) 124. Telephones 118, 118a and/or PC 120 may include devices such as a hardwired desk phone, a wireless phone (e.g., a DECT-compatible phone), a softphone (e.g., a PC application), a smart phone, a tablet computer, and so forth. One or more of the functions of firewall 112, call server 114 and VPN client 114a may be provided by a combined SSL VPN client 122 such as the Avaya™ IP Office IP-PBX (“IP Office”).

Customer premises domain 110 may further include one or more computers 126, upon may be are executing one or more client application programs (“apps”) 128. One or more of client app 128, at some point in the future, will need to use a secure VPN tunnel from itself to a server app 12 in server domain 150.

Server domain 150 may include a firewall 152 that protects domain 150 from malicious attacks. Firewall 152 may be communicatively connected with SSL VPN gateway 154, which may be used to implement a secure client-server communication session (e.g., a VPN tunnel). SSL VPN gateway 154 may be communicatively connected with one or more agents 158-1 through 158-N, and/or one or more servers 160, upon may be are executing one or more server apps 162. Individual agents may be referred herein as agent 158-n or as agent 158.

Domain 110 may include multiple instances of VPN client 114a within a single combined SSL VPN client 122. Instances of VPN client 114a connect to a respective server domain 150, and in particular connecting to a respective SSL VPN Gateway 154 in server domain 150, in order to provide secure remote connectivity.

A secure VPN tunnel between domain 110 and domain 150 may be used to transport a secure communication session between App 162 executing on server 160 and SSL VPN client 122. In some embodiments if a network address and port translation (NAPT) is appropriately configured on SSL VPN client 122, the secure VPN tunnel may further extend to connect with client app 128 executing on computer 126. In some embodiments, computer 126 and PC 120 may be the same.

Authentication may be performed by use of a Remote Authentication Dial-In User Service (“RADIUS”) server 164, which may be implemented as an app component on server 160. RADIUS is a client/server protocol that runs in the application layer, using UDP as transport. A server such as server 160, VPN Gateway 154, and VPN client 114a control network-based remote access in which VPN Gateway 154 includes a RADIUS client component that communicates with the RADIUS server 164. A RADIUS process includes authenticating users or devices before granting them access to a network, authorizing those users or devices for certain network services, and accounting for usage of those services.

When an instance of VPN client 114a connects to an instance of VPN Gateway 154, an authentication process may be performed, which in some embodiments may involve one step. First, an exchange of SSL Transmission Level Security (“TLS”) X.509 certificates takes place on the server side. Certificate validation may be based on X.509 Certificate Authority certificates that are installed in a trusted storage location, such as a Trusted Certificate Store (“TCS”) associated with combined SSL VPN client 122. For example, VPN Gateway 154 sends its certificate to VPN client 114a, whereupon VPN client 114a either accepts or rejects the certificate. In some embodiments, this provides a first authentication factor and the TLS connection verification process ends.

In other embodiments when an instance of VPN client 114a connects to an instance of VPN Gateway 154, the authentication process may include a second-factor authentication, such that a second step is involved.

The second step of the second-factor authentication process may occur if VPN client 114a sends its own certificate to VPN gateway 154 to have the certificate authenticated by VPN gateway 154. In other embodiments, the second step of the second-factor authentication process may occur when a RADIUS server 164 associated with VPN Gateway 154 performs an authentication of the SSL VPN service username/password. Functionality for this authentication is provided by a tunnel negotiation signaling protocol between VPN Gateway 154 and VPN client 114a. The signaling protocol is based on SOCKS5 messaging as known in the art.

In other embodiments, per the TLS specification, VPN client 114a may then provide its certificate to VPN Gateway 154, which then either accepts or rejects the certificate. This embodiment may be referred to herein as a second-step authentication process. However, embodiments in accordance with the present invention, when referring to a second factor authentication, will refer to a process in which after a TLS connection is established (i.e., accepted by VPN Gateway 154), a second authentication is performed based on username and password, in order to allow the SSL VPN tunnel to connect.

In some embodiments and usage scenarios in accordance with the present invention, a telephone caller may wish to use shortcodes to change tunnel configuration and, therefore, the telephone caller needs to be authenticated. A telephone user may be authenticated on the call server by a sequence initiated when the telephone user plugs-in a phone. The login and password for the telephone user may be set up during call server configuration. The telephone phone users' credentials are independent of the credentials for the VPN gateway and Radius server. The VPN gateway credentials and Radius credentials are stored on the call server only for the SSL VPN service used to establish an SSL VPN tunnel. In some embodiments, telephone users may be associated with a group (e.g., an administrative group), and members of the group may be configured with different or additional privileges, such that permission to use shortcodes to bring up or down SSL VPN services may be allowed or denied. Rights of user groups and specific users are flexible and fully configurable through an appropriate system control interface.

Upon successful authentication by VPN Gateway 154, the VPN Client 114a exchanges dynamic configuration parameters with VPN Gateway 154. Exchanged parameters may include a tunnel IP address and a netmask that are assigned to the SSL VPN service account name. VPN Client 114a already has a LAN IP address to reach the Internet. The SSL VPN tunneling technology is based on creating a secure (i.e., encrypted) communication link, or “secure connection,” by use of an existing LAN connection. The secure connection is based on a TLS connection which may include a TCP connection with security-related content flowing inside the connection. The secure connection carries both signaling and data traffic that must travel securely between the VPN Client 114a and the VPN Gateway 154. When a VPN Client tunnel is established as a secure TCP connection, VPN Gateway 154 reaches the tunnel endpoint by use of an assigned tunnel IP address that was provided by VPN Gateway 154 when the SSL VPN tunnel was established.

At VPN Client 114a, the tunnel IP address is visible when VPN Client 114a successfully connects with VPN Gateway 154, and the tunnel endpoint shows up as a new system IP interface like another LAN but the media type is referred to as TUN/TAP instead of Ethernet. Account name may be a 32 character string which represents a valid user who is allowed to establish an SSL VPN tunnel. The account name may be configured either on VPN Gateway 154 itself in its local database or may be configured in the RADIUS server 164 sitting behind VPN Gateway 154. VPN Gateway 154 may then send the account name and password authentication request to RADIUS server 164. If the request is successful, RADIUS server 164 returns for this account name the corresponding tunnel IP address, netmask, and group name. There is a one-to-one relationship between SSL VPN tunnel endpoint and account name such that each SSL VPN client connection can get a unique tunnel IP address assigned to it when it connects with VPN Gateway 154.

Each SSL VPN service account name in RADIUS is configured with a static tunnel IP address. RADIUS requires a static IP address per account name. In some embodiments, instead of using RADIUS for authentication, VPN Gateway 154 may be configured to use its local database, in which case the tunnel IP address would be assigned from a pool of IP addresses. An embodiment using a RADIUS server 164 allows for predicting ahead of time which Account name will get which tunnel IP address. The later embodiment is substantially equivalent to a DNS server fully qualified domain name (“FQDN”) mapping to a specific IP address.

Upon successful authentication, split tunneling routes may be used. Split tunneling instructs VPN Client 114a to install specific subnet entries in its routing table to use the SSL VPN tunnel for traffic with IP address destinations falling within the range of the specific subnet entries. If split tunneling was not used, then the VPN Client 114a default route next hop IP address would become the address of VPN Gateway 154 for all its traffic for as long as the SSL VPN tunnel is connected with VPN Gateway 154. Embodiments in accordance with the present invention may use split tunneling in order to allow a VPN Client 114a to reach a VPN Gateway 154 while in parallel an end customer (i.e., a user of phone 118, phone 118a, PC 120, or a different client app 128) may reach the Internet without going over the SSL VPN tunnel.

VPN Gateway 156 and/or VPN Client 114a may be configured to provide a default route. The default route is also known as a default gateway. The default route is the location that received traffic is routed to if the destination IP address of the received IP traffic does not match a local host within the local subnet range of the respective VPN Gateway 156 and/or VPN Client 114a.

The split tunneling route may be added in the routing table in VPN Client 114a in order to reach a set of private networks configured as a service provider/business partner (“SP/BP”) infrastructure, associated with VPN Gateway 154, where support agents may be located, i.e., in domain 150. The private networks (not illustrated in FIG. 1) are located in domain 150, reachable through LAN 156, and have IP subnet ranges that are advertised in the split network route setup. The split tunneling routes may be torn down and disconnected when the SSL VPN service is no longer needed. Any default route that may be set up in VPN client 114a is undisturbed if a split tunneling route is torn down.

The SSL VPN service is configured as always-on. Once connected, it is not configured to go down unless there are network connectivity issues that interfere with contacting VPN Gateway 154. The service is designed to be resilient, so if there is an interruption the service will attempt to reestablish a connection periodically, such as every minute. The wait period between reconnection attempts may be configurable.

Various methods may be used to enable, disable, or reconfigure VPN client instances that are provided by combined SSL VPN client 122. For example:

1) Either a thick client (i.e., a relatively more robust terminal) or a thin client (i.e., a relatively less robust terminal) may configure the SSL VPN service. For example, a thick client may be a communication manager responsible for managing an entire domain, such as Avaya™ IP Office Manager™. A thin client may be a web based interface;

2) A monitoring tool may be used to monitor the SSL VPN service. The monitoring tool user interface may include a control (e.g., button, link, keystroke shortcut, etc.) used to enable or disable an SSL VPN service instance. In some embodiments, a thick monitoring tool may be a JAVA based application running on a PC that is connected to IP Office, and is usually located at the customer premise. The thick monitoring tool may be configured to monitor substantially all dynamic field values related to the SSL VPN service. In some embodiments, a thick logging application may be used to monitor SSL VPN tunnel events. In some embodiments, the SSL VPN tunnel status may also be monitored for simple on/off status changes by use of a telephone. In some embodiments, a thin monitoring tool, e.g., a web based configuration tool, may be used to provide dynamic information about the SSL VPN service in addition to configuring it.

3) A unique configurable string of phone keypad digits and characters (known as shortcodes) may be configured to be recognized within VPN Client 114a/Call Server 114. Call Server 114 may be used to enable or disable an SSL VPN service instance. Call server 114 recognizes the shortcodes and the shortcode action is initiated by call server 114 on VPN client 114a, such that either side of the VPN tunnel may enable or disable the VPN tunnel by use of the shortcodes. When a phone 118 or 118a dials a shortcode, the VPN client 114a and call server 114 recognizes the shortcode and acts on the shortcode to either enable or disable a specific SSL VPN service configured on VPN client 114a. Since there may be more than one SSL VPN service configured on VPN client 114a and call server 114, the shortcode may include a target ID such that instructions to enable or disable SSL VPN service are targeted to a specific SSL VPN service. Substantially any phone 118, 118a connected to VPN Client 114a may dial the shortcode to enable or disable the specified SSL VPN service instance. A shortcode may include a special telephone number, shorter than a full 10-digit telephone number, that can be used to address messages from an end-user's telecommunication terminal to a network element.

Limit may be provided on which SSL VPN service instance phone 118 or 118a may control. A set of shortcodes may be configured system-wide for all users to invoke, and another set of shortcodes may be configured for members of a predetermined user group to invoke, and another set of shortcodes may be configured for a specific user to invoke. Each SSL VPN service instance may be associated with a shortcode number to enable (or disable) a particular SSL VPN service instance;

4) If Call Server 114 is configured to recognize a shortcode string as described above, the end user's communication device such as phone 118, PC 120 or client app 128 may include a control (e.g., button, link, keystroke shortcut, etc.) that is programmed to provide the shortcode string automatically. When the control is exercised on the end user's communication device, the shortcode string described above is automatically dialed instead of the user manually dialing it;

5) A control on the end user's communication device may be programmed to provide a capability to switch between multiple instances of SSL VPN services. For example, when an SSL VPN service associated with the control is enabled or disabled, a visual indicator (e.g., an icon, an LED etc.) associated with the control may be activated or deactivated, respectively, to indicate an enablement status of the VPN service. The SSL VPN service instance may be toggled between enabled and disabled by, e.g., repeatedly pressing or exercising the associated control on the end user's communication device;

6) The SSL VPN client 122 may provide Interactive Voice Response (“IVR”) voice prompts and menus in order to give an end-user an ability to navigate the voice prompt menus to enable or disable an SSL VPN service instance. The IVR system may be reached by dialing an access number, or by having the SSL VPN client 122 redirecting a call to it;

7) SSL VPN client 122 (which may also represent an interface for a trunk (e.g., PRI, SIP, H.323 and/or SCN trunk) entering the VPN Client 114a/call server 114 where call attempts are handled) may be programmed to enable or disable an SSL VPN service by inspecting a Calling Line IDentifier (CLID) of an incoming call. For example, VPN Client 114a/call server 114 may receive a call attempt for a number (i.e., a CLID). VPN Client 114a/call server 114 may be configured, for instance by way of a tabular entry in a routing module, to recognize a predetermined CLID (e.g., 613-123-4567). When VPN Client 114a/call server 114 receives a call to the predetermined CLID, a specified action or function may be invoked. For example, the action may be to “enable SSL VPN service #1.”

8) A sufficiently-enabled VoIP phone 118 or other terminal device (e.g., PC 120, or analog phone 118a connected through VPN client 114a/call server 114) may navigate to a menu option either by using arrow keys, DTMF tones, a predefined shortcut, or the like, and by selecting the appropriate menu option enable or disable an SSL VPN service instance on SSL VPN client 122.

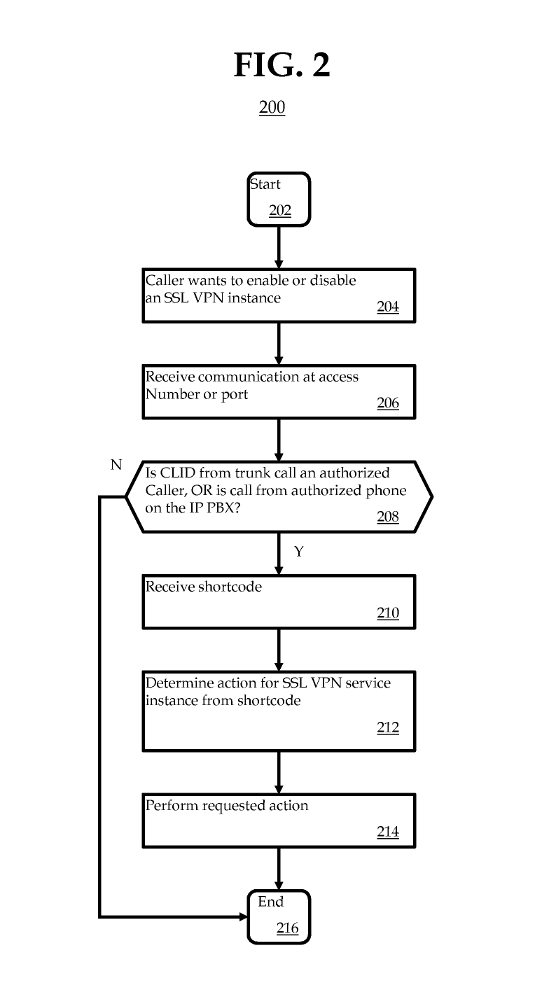

FIG. 2 illustrates an exemplary method to control a VPN connection by use of signals from a less robust terminal. Method 200 begins at step 202. At step 204, a caller wants to enable or disable an SSL VPN instance. In particular, the VPN connection may be established or taken down by a VPN client in the same domain as an end-user who will be using the VPN connection or from a less robust terminal either in domain 110 or domain 124.

Next, at step 206, a communication is received at an access number or access port. For example, the access number may be a dedicated telephone number used for configuring VPN services, or the access port may be an interface to communication terminals within the domain, the access port being configured to recognize certain codes such as shortcodes, DTMF signals, menu selections, etc.

Next, at step 208, an identity is checked of the communication terminal that sent the communication received in step 206. For example, the identity may be checked by way of a caller ID (i.e., CLID) if the call is from a trunk. Alternatively, if the call is from an IP PBX, it may be checked against a list of authorized phones. The identity is then checked against authorized terminals that may control the VPN connection. If the communication terminal is not authorized, control of method 200 passes to step 216 at which method 200 terminates. If the communication terminal is authorized, control of method 200 passes to step 210.

At step 210, a code such as a shortcodes, DTMF signals, menu selections, etc. is received by a processor coupled to a memory. Control then passes to step 212, at which the processor determines what action is intended, and the VPN connection that is the intended target.

Next, at step 214, the processor performs the requested action on the VPN connection. Control of method 200 then passes to step 216 at which process 200 terminates.

The SSL VPN client 122 may be programmed to recognize telephony features tailored to control instances of SSL VPN service. Users' telecommunication devices such as phones 118, 118a, and/or PCs 120 may be programmed with buttons or other user-friendly single-action controls in order to easily provide the telephony features that SSL VPN client 122 may be programmed to recognize. Control of SSL VPN service instances may include changes to the status of an SSL VPN service instance provided by SSL VPN client 122. Establishment of the SSL VPN service connection to a VPN gateway server 154 should be initiated from the SSL VPN client side, i.e., from SSL VPN client 122.

Embodiments in accordance with the present invention provide multiple methods for enabling and/or disabling SSL VPN service on SSL VPN client 122, and those methods may use telephony features of phones 118, 118a, and/or PCs 120 instead of more resource-intensive configuration or monitoring application programs.

Embodiments in accordance with the present invention enable end-users of less robust telecommunication terminals (e.g., analog phone 118a) to control SSL VPN service, at least by enabling and/or disabling a selected SSL VPN service. The control may be accomplished by an end-user of the less robust terminal dialing a short code or other access number. The call server 114 may then provide a menu of options to the less robust terminal, whereupon the less robust terminal may select the desired option through their phone by DTMF tone. By providing a simple interface, embodiments avoid a need for a user of a less robust terminal to call a specialist or technician to receive troubleshooting support for configuring or reconfiguring their VPN service, and potentially avoiding a need to dispatch a technician to configuring or reconfiguring the VPN service.

Security issues, certificate issues, proper accounting, etc., relating to opening and closing a VPN tunnel need special attention. Opening the VPN tunnel is controlled by a customer (i.e., client) in domain 110 because in view of security concerns the VPN tunnel can only be initiated by a customer. Closing the VPN tunnel can be done by either the client (e.g., a customer using phone 118 and/or PC 120) or the server (i.e., by server 160) because remote support allows direct connectivity to SSL VPN client 122 over a secure transport layer security (“TLS”) connection, for example a VPN tunnel.

Multiple SSL VPN tunnels, from multiple VPN Gateways 154 or equivalents, may be simultaneously connected to SSL VPN client 122. Some of these SSL VPN tunnels may connect with domains other than domain 150 (not illustrated in FIG. 1). A customer in domain 110 may selectively enable or disable one or more of these SSL VPN tunnels. For example if SSL VPN client 122 is configured to recognize shortcodes for VPN control, one predetermined shortcode number per instance and per action may be assigned (i.e., enable or disable) so that the customer using phone 118, phone 118a and/or PC 120 can dial the appropriate shortcode from a phone in order to open or to close the selected VPN tunnel. A shortcode table may be stored in memory, which maps shortcode numbers to an action and an SSL VPN service name. When using set-based administration menus, a predetermined menu button on the phone may be provided such that, when activated, instructions are provided on-screen that allow a user to select an action from among a menu or submenu of items. The actions that the user can select may include actions related to SSL VPN service, such as viewing tunnel on-off status, enabling a tunnel, disabling a tunnel, and so forth.

To configure an SSL VPN tunnel using SSL VPN client 122, an end-user needs to know a unique “Alarm ID” and tunnel IP address assigned to the system. The assignment may be made by registering the SSL VPN client 122 with a global system manager. The Alarm ID may be, e.g., a ten digit number that is used as an SSL VPN service account name. This Alarm ID is associated with a secret password that is configured in the SSL VPN service at SSL VPN client 122.

Configuring the SSL VPN service can be accomplished in at least two ways: First, a user may use a “thick” (i.e., robust) configuration application (e.g. Avaya™ IP Office Manager or Web Manager) to create the SSL VPN service using the corresponding VPN Gateway 154 IP address or Fully Qualified Domain Name (“FQDN”), and Alarm ID as the account name and secret password;

Second, a user may use an on-boarding XML file that had been provided by a Global Registration Tool (“GRT”) application (or equivalent) at registration time. The on-boarding XML file contains SSL VPN service data and is digitally signed using an encrypted password, such that tampering of the XML file is prevented. The on-boarded XML file may be uploaded and applied to Call Server 114 in order to auto-configure the SSL VPN service that will be used by VPN Client 114a. If the secret password becomes compromised, the Alarm ID password can be reset, which will prevent SSL VPN communication until the SSL VPN client password is updated. The customer can then update the secret password on the SSL VPN service themselves or can be given an updated on-boarding XML file containing the new password in encrypted format, which is then uploaded again to the Call Server 114.

If configuring an SSL VPN service by entering a shortcode using phone 118 or 118a, the recognized system-wide shortcodes may be defined by embedding them in the on-boarding XML file for users to invoke. For example a shortcode may be in the form *SSLXY (e.g., *77511), such that “SSL” is the SSL VPN service identifier, “X” (1≦X≦9) indicates the SSL VPN service instance, and “Y” indicates the action (Y={0,1}, 1=enable and 0=disable).

With respect to security certificates (e.g., X.509 certificates), when the SSL VPN service is configured manually, a valid X.509 certificate from a Certificate Authority (“CA”) such as Verisign™ should be installed in a trusted storage location such as a Trusted Certificate Store (“TCS”) associated with combined SSL VPN client 122. When applicable, a self-signed CA certificate is also accepted. However, if the uploaded on-boarding XML file already contains a valid CA certificate, the XML file may be installed automatically into the TCS. The CA certificate is supplied to the combined SSL VPN client 122 when the VPN client 114a attempts to establish a connection with VPN Gateway 154. When the connection is attempted, combined SSL VPN client 122 will validate the VPN Gateway 154 certificate using the installed CA certificate from its TCS.

Embodiments of the present invention include a system having one or more processing units coupled to one or more memories. The one or more memories may be configured to store software that, when executed by the one or more processing unit, implements processes described above.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method to control a virtual private network (VPN) connection, comprising the steps of:
establishing a VPN connection between a VPN client associated with a communication terminal of an end-user and a remote VPN gateway;
configuring the VPN client to recognize a shortcode provided by the communication terminal; and
controlling the VPN connection based upon the shortcode.

2. The method of claim 1, further comprising the step of establishing a second VPN connection between the VPN client and a second remote VPN gateway.

3. The method of claim 2, further comprising the step of displaying on the communication terminal of the end-user a status of more than one VPN connection involving the VPN client.

4. The method of claim 3, wherein the communication terminal of the end-user comprises a monitoring module, wherein the monitoring module is configured to accept a user control.

5. The method of claim 4, wherein the monitoring module is configured to provide a shortcode.

6. The method of claim 2, wherein the communication terminal is selectively configurable to connect to a second VPN connection.

7. The method of claim 1, further comprising the step of providing communication data from the VPN connection to the communication terminal.

8. The method of claim 1, further comprising the step of providing communication data from the VPN connection to a second communication terminal.

9. The method of claim 1, further comprising the step of verifying an authorization for the communication terminal to control the VPN connection.

10. The method of claim 1, further comprising the step of supplying an identifier in order to identify the VPN connection to control.

11. The method of claim 1, further comprising the step of providing a menu-based control interface to the communication terminal in order to control the VPN connection.

12. The method of claim 1, wherein controlling the VPN connection comprises disabling the VPN connection.

13. The method of claim 1, wherein controlling the VPN connection comprises switching among multiple instances of VPN connections.

14. A system to control a virtual private network (VPN) connection, comprising:
a VPN client;
a communication terminal associated with the VPN client, wherein the communication terminal is in a same domain as the VPN client;
a processor coupled to a memory, wherein the processor is configured to establish a VPN connection between the VPN client and a VPN gateway, wherein the VPN gateway is in a domain that is different than the domain of the VPN client; and
a module configured to control the VPN connection by use of signals from the communication terminal

15. The system of claim 14, wherein the signals comprise shortcode signals.

16. The system of claim 14, further comprising a module configured to display on the communication terminal a status of more than one VPN connection involving the VPN client.

17. The system of claim 14, wherein the communication terminal comprises a monitoring module that is configured to accept a user control.

18. The system of claim 17, wherein the monitoring module is configured to provide a shortcode.

19. The system of claim 14, further comprising a module configured to provide communication data from the VPN connection to a second communication terminal.

20. The system of claim 14, further comprising an authorization module configured to authorize the communication terminal to control the VPN connection.
